(19) United States
(12) Patent Application Publication
(10) Pub. No.: US 2019/0140532 A1
(43) Pub. Date: May 9, 2019

(54) Magnetic circuit structure of BLDC motor and permanent magnet embedded rotor thereof

(71) Applicant: RENUN MECHANICAL & ELECTRICAL CO., LTD, Zhuji City, Zhejiang (CN)

(72) Inventors: Kewei WANG, Zhuji City (CN); Ruiguang WEN, Zhuji City (CN)

(73) Assignee: Renun Mechanical & Electrical Co., Ltd, Zhuji City, Zhejiang (CN)

(21) Appl. No.: 14/123,203

(22) PCT Filed: Nov. 18, 2013
(86) PCT No.: PCT/CN2013/087298

§ 371 Date: Apr. 16, 2015

(30) Foreign Application Priority Data
Oct. 11, 2013 (CN) 201310472834.8
Oct. 11, 2013 (CN) 201320626973.7

(51) Int. Cl. H02K 29/08; H02K 1/27; H02K 1/32; H02K 29/03

(52) U.S. Cl. CPC H02K 29/08; H02K 1/276; H02K 2211/03; H02K 29/03; H02K 1/32

(57) ABSTRACT

A magnetic circuit of a BLDC motor includes a stator iron core, a rotor iron core, permanent magnets and a magneto-sensitive sensor. The permanent magnets are longer than the rotor iron core; the magneto-sensitive sensor is provided at a protrusion of the rotor iron core and far away from an impact of a magnetic field of a stator; a magnetic screening slot and a positioning convex portion are respectively provided at each end of said permanent magnet slot; the magneto-sensitive sensor senses a magnetic field of two ends of each permanent magnet, rather than a combined magnetic field of the rotor iron core and each permanent magnet, so as to effectively reduce Hall signal jitters caused by irregular and unclear boundaries between two magnetic poles on a surface of the rotor. A permanent magnet embedded rotor thereof is also disclosed.

### CROSS REFERENCE OF RELATED APPLICATION

This is a U.S. National Stage under 35 U.S.C 371 of the International Application PCT/CN2013/087298, filed Nov. 18, 2013, which claims priority under 35 U.S.C. 119(a-d) to CN 201310472834.8 and CN 201320626973.7, filed Oct. 11, 2013.

### BACKGROUND OF THE PRESENT INVENTION

### Field of Invention

The present invention relates to a motor having a non-mechanical commutating device and magnetic circuit parts thereof, and more particularly to a brushless direct current (BLDC) motor having a magnetic effects device and a structure of magnetic circuit parts of a permanent magnet embedded rotor.

### Description of Related Arts

The BLDC motor mainly comprises an electronic switching and commutating device, a permanent magnet synchronous motor and a position sensor. The position sensor transforms the position of the rotor magnet into the electric signals for controlling the electronic switching and commutating device, in such a manner that the phase currents of the stator commutates in the right order with the changing position of the rotor. Thus the electric magnetic field keeps changing with the rotating rotor, and the rotating magnetic field which synchronizes with the rotating rotor and drives the rotor to rotate with the largest torque is generated. The position sensor of the BLDC motor is usually the magneto-sensitive position sensor, wherein the magneto-sensitive element mainly works according to the magnetic effects of currents, more specifically to the Hall effects or the magnetoresistance effects. In the BLDC motor having the magneto-sensitive position sensor, the magneto-sensitive sensing element, such as the Hall element, the magneto-sensitive diode, the magneto-sensitive bipolar transistor, the magneto-sensitive resistor and the application-specific integrated circuit, is mounted on the stator components for detecting the changes of the magnetism field generated by the rotation of the permanent magnet rotor. The Chinese patent application, CN101388591A (Application Number 200810062945.0), disclosed the assembling structure of the Hall device in the BLDC motor in the field of electric motor manufacture which comprises the circuit board, the Hall which is welded to the circuit board by the Hall pin, the coil bobbin fixed to the stator plate, wherein the mutually cooperative mounting holes are formed between the end part of the outer ring of the coil bobbin and the circuit board; the metal sheet is embedded on at least one surface of the circuit board corresponding to the position of the mounting holes; the mounting hole passes through the metal sheet; the pre-positioning pin is formed on the end part of the outer ring of the coil bobbin; the pre-positioning hole corresponding to the pre-positioning pin is provided on the circuit board, for preventing the part of the circuit board corresponding to the mounting hole from cracking. Although the problem of positioning the Hall element is solved via the assembling structure, the Hall position sensor of the assembling structure is usually mounted between the slots of the stator and no higher than the stator; and the distance between the Hall position sensor and the magnetic poles of the permanent magnet rotor is relatively large. Such a mounting manner has following problems.

Firstly, the Hall position sensor is liable to be disturbed by the magnetic field of the stator, especially under the high-power application situations.

Secondly, the boundary between the two magnetic poles of the embedded permanent magnet rotor is irregular and unclear, which may cause the Hall signal jitters, so as to affect the smooth operation and the working efficiency of the electric motor.

Thirdly, the Hall position sensor is liable to be affected by the high temperature of the stator, especially under the high-power application situation.

Moreover, in order to reduce the magnetic flux leakage coefficient and increase the utilization of the permanent magnetic materials, the conventional permanent magnetic BLDC usually comprises the magnetic screen means, i.e., providing the magnetic screening air gaps at the two ends of the embedded permanent magnet. The Chinese Patent ZL01121704.9 (Publication Number CN1201463C) disclosed the permanent magnet rotor with a rotor core having permanent magnets embedded therein, wherein the permanent magnet rotor comprises slits where the permanent magnets are embedded, and bridging parts provided at the internal side of the longitudinal ends, near the longitudinal middle portion, of the slits; the bridging parts respectively connect the radially outer portions to the radially inner portions, relative to each slit, of the rotor core; and the longitudinal ends of the slits are provided at the outer circular surface of the rotor core. The Chinese patent application 201210316633.4 (Publication Number CN102857000A) disclosed the embedded sine-profile permanent motor rotor, wherein a plurality of consecutively connected arc protrusions is radially provided on the surface of the rotor; the rotor is separated into a plurality of equal areas by the ligature of the rotor axis and the crosspoint of each two adjacent protrusions; the two grooves in the invertedly splayed shape are provided in each area; and the permanent magnets are inserted into the grooves. However, the magnetic screening air gap ω and the sheet margin b of the conventional permanent magnet embedded rotor cause the magnetic circuit mutation; as shown in FIGS. 9 and 10, the partial magnetic flux direction and the magnetic flux density mutates, which further causes following two problems.

Firstly, the superficial magnetism waveform of each magnetic pole is saddle-shaped which is shown as m0 of FIG. 11; the peak values and the valley values have relatively large difference, so as to cause the torque fluctuation and affect the smooth operation of the motor.

Secondly, the two convex waveforms, shown as t in FIG. 11, emerge at the boundary between the two magnetic poles; the two convex waveforms are caused by the structural defect of the magnetic circuit and thus able to cause signal jitters in the magneto-sensitive position sensor, such as in the Hall element, which further results in the driving waveform distortion outputted by the electronic switching and commutating device, the increased fluctuation of the outputted torque, the increased noise and shakes during operation, the decreased operation efficiency and the increased loss.

### SUMMARY OF THE PRESENT INVENTION

An object of the present invention is to provide a BLDC motor able to solve a problem of signal jitters in a Hall position sensor caused by an irregular and unclear boundary between two magnetic poles on a rotor surface and to efficiently reduce effects on the Hall position sensor by a magnetic field and a temperature of a stator, so as to improve operation smoothness and operation stability of the BLDC motor.

Accordingly, in order to accomplish the above object, the present invention adopts following technical solutions.

A BLDC motor magnetic circuit comprises a stator iron core 5, a rotor iron core 3 having a plurality of stacked rotor punched sheets 30, permanent magnets 1 embedded inside the rotor iron core 3, and a magneto-sensitive sensor 4 for detecting changes in a magnetic field of a rotor to control commutating. The rotor iron core 3 is as long as the stator iron core 5.

The permanent magnets 1 are longer than the rotor iron core 3; each permanent magnet 1 has at least one end protruding out of an end surface of the rotor iron core 3 to form at least one protrusion of the permanent magnet 1.

The magneto-sensitive sensor 4 is provided at an end of the rotor iron core 3 which is close to the protrusion of the permanent magnet 1 and far away from an impact of the magnetic field of the stator; the magneto-sensitive sensor 4 detects a position of the rotating rotor by sensing the changes of the magnetic field of the protrusions of the permanent magnets 1.

Preferably, the magneto-sensitive sensor 4 is mounted upright on a circuit board 41; a sensing part of the magneto-sensitive sensor 4 is close to an external side of the protrusions of the permanent magnets 1 and senses the changes in the magnetic field of the external side of the protrusions of the permanent magnets 1 when the rotor is rotating.

Preferably, the magneto-sensitive sensor 4 lies down on a circuit board 41; a sensing part of the magneto-sensitive sensor 4 is close to end surfaces of the permanent magnets 1 and senses the changes in the magnetic field of end parts of the permanent magnets 1 when the rotor is rotating.

Preferably, the protrusions of the permanent magnets 1 respectively protruding out of the two ends of the rotor iron core 3 are identically long.

Further preferably, a permanent magnet front end cover 12 and a permanent magnet back end cover 11 are respectively provided at the two ends of the rotor iron core 3; the permanent magnets 1 pass through the rotor iron core 3 and are fixed on a rotating shaft 31 via the permanent magnet front cover 12 and the permanent magnet back cover 11, so as to form the integrated BLDC rotor.

Another object of the present invention is to provide an embedded permanent magnet rotor of the BLDC motor magnetic circuit which is able to improve a saddle shape of each magnetic pole to generate waveforms inclined to flatten, and to efficiently suppress two superficial magnetism convex waveforms emerging at a boundary between two magnetic poles, so as to obviously improve an integral performance of the motor, to increase smoothness of output torque and an operation efficiency and to decrease shakes.

Accordingly, in order to accomplish the above object, the present invention further adopts following technical solutions.

A permanent magnet embedded rotor of the BLDC motor magnetic circuit comprises the rotor iron core having the plurality of the stacked rotor punched sheets 30, p pairs of permanent magnet slots 2 uniformly provided at a circumference of the rotor punched sheets 30, and p pairs of permanent magnets 1 respectively embedded in the permanent magnet slots 2, wherein p is an integer no less than 1; outer peripheries of the rotor punched sheets 30 are standard circular arcs.

The two ends of each permanent magnet 1 both tilt inwardly at a tilting angle Q, wherein Q=5°˜20°;

the two ends of each permanent magnet slot 2 respectively have a magnetic screening slot 20; and

positioning convex portions 21 for mounting the permanent magnets 1 are provided at boundaries between the two ends of each permanent magnet slot 2 and each magnetic screening slot 20.

Preferably, the magnetic screening slot 20 is a bar-shaped space extending along an end surface of the permanent magnet 1; a cross section of the bar-shaped space is formed by a straight line substantially parallel with the end surface of the permanent magnet 1 and smooth curves connected between two ends of the straight line and the permanent magnet slot 2; and sector-shaped connecting zones 22 of the punched sheets are provided between the two adjacent magnetic screening slots 20.

Preferably, the magnetic screening slot 20 is a sector-shaped space extending along an end surface of the permanent magnet 1; a cross section of the sector-shaped space is formed by a straight line substantially radially parallel with the rotor punched sheets and smooth curves connected between two ends of the straight line and the permanent magnet slot 2; and bar-shaped connecting zones 22 of the punched sheets are provided between the two adjacent magnetic screening slots 20.

Further preferably, a distance F between boundaries of the two adjacent magnetic screening slots 20 is 0.5˜3 mm.

Further preferably, a distance G between a boundary of the magnetic screening slot 20 and the outer arc-shaped boundary of the rotor punched sheets 30 is 0.5˜3 mm.

The present invention has following benefits.

Firstly, the magneto-sensitive sensor of the BLDC motor magnetic circuit senses the magnetic field of the ends of the permanent magnets, rather than a combination magnetic field of the rotor iron core and the permanent magnets, which efficiently reduces the Hall signal jitters caused by the irregular and unclear boundary of the two magnetic poles on the surface of the rotor; the magneto-sensitive sensor of the BLDC motor magnetic circuit is far away from an impact of the magnetic field and the temperature of the stator and further has the improved smoothness and the improved stability.

Secondly, the embedded permanent magnet rotor has a reasonable arrangement and the permanent magnets with the two tilted ends, which obviously improves partial magnetic flux directions within the rotor and eliminates magnetic density mutations; thus the superficial magnetism curves of the rotor are greatly improved and the convex waveforms emerging on the superficial magnetism curves are effectively suppressed, so as to greatly reduce the Hall signal jitters when commutating, avoid distorted waveforms outputted by a driving circuit and reduce output torque fluctuations, so that the motor operates more smoothly and more efficiently.

Thirdly, the BLDC motor magnetic circuit and the embedded permanent magnet rotor thereof improve the average superficial magnetism value corresponding to each magnetic pole of the rotor over 50%, compared with prior arts; meanwhile, the superficial magnetic waveform corresponding to each magnetic pole is obviously improved, so as to improve the integral performance and the power density.

Fourthly, the BLDC motor has a good performance of thermal dissipation and saves raw materials because of the embedded permanent magnet rotor; compared with the conventional rotor comprising a salient pole rotor or a rotor having a V-shaped recess, the BLDC motor of the present invention obtains better effects of dynamic balance and less wind noise, so as to accomplish lower cost and better performance.

### BRIEF DESCRIPTION OF THE DRAWINGS

FIG. 1 is an axially sectional view of a BLDC motor magnetic circuit according to a preferred embodiment of the present invention.

FIG. 2 is an alternative mode of the BLDC motor magnetic circuit according to the preferred embodiment of the present invention.

FIG. 3 is a radially sectional view of the BLDC motor magnetic circuit according to the preferred embodiment of the present invention.

FIG. 4 is a sketch view of a permanent magnet embedded rotor of the BLDC motor magnetic circuit according to the preferred embodiment of the present invention.

FIG. 5 is a sketch view of a rotor punched sheet of the permanent magnet embedded rotor according to the preferred embodiment of the present invention.

FIG. 6 is an enlargement view of B of FIG. 5.

FIG. 7 is a sketch view of tilting angles of permanent magnets embedded in a rotor according to the preferred embodiment of the present invention.

FIG. 8 is an alternative mode of the permanent magnet embedded rotor according to the preferred embodiment of the present invention.

FIG. 9 is a sketch view of a conventional permanent magnet embedded rotor of a conventional BLDC motor according to prior arts.

FIG. 10 is an enlargement view of A of FIG. 9.

FIG. 11 is a distribution diagram of superficial magnetism of the conventional permanent magnet embedded rotor according to the prior arts.

FIG. 12 is a distribution diagram of the superficial magnetism of the permanent magnet embedded rotor according to the preferred embodiment of the present invention.

1—permanent magnet; 11—permanent magnet back end cover; 12—permanent magnet front cover; 2—permanent magnet slot; 20—magnetic screening slot; 21—positioning convex portion; 22—connecting zone of punched sheet; 3—rotor iron core; 30—rotor punched sheet; 31—rotating shaft; 4—circuit board; 41—magneto—sensitive sensor; 5—stator iron core.

### DETAILED DESCRIPTION OF THE PREFERRED EMBODIMENT

These and other objectives, features, and advantages of the present invention will become apparent from the following detailed description, the accompanying drawings.

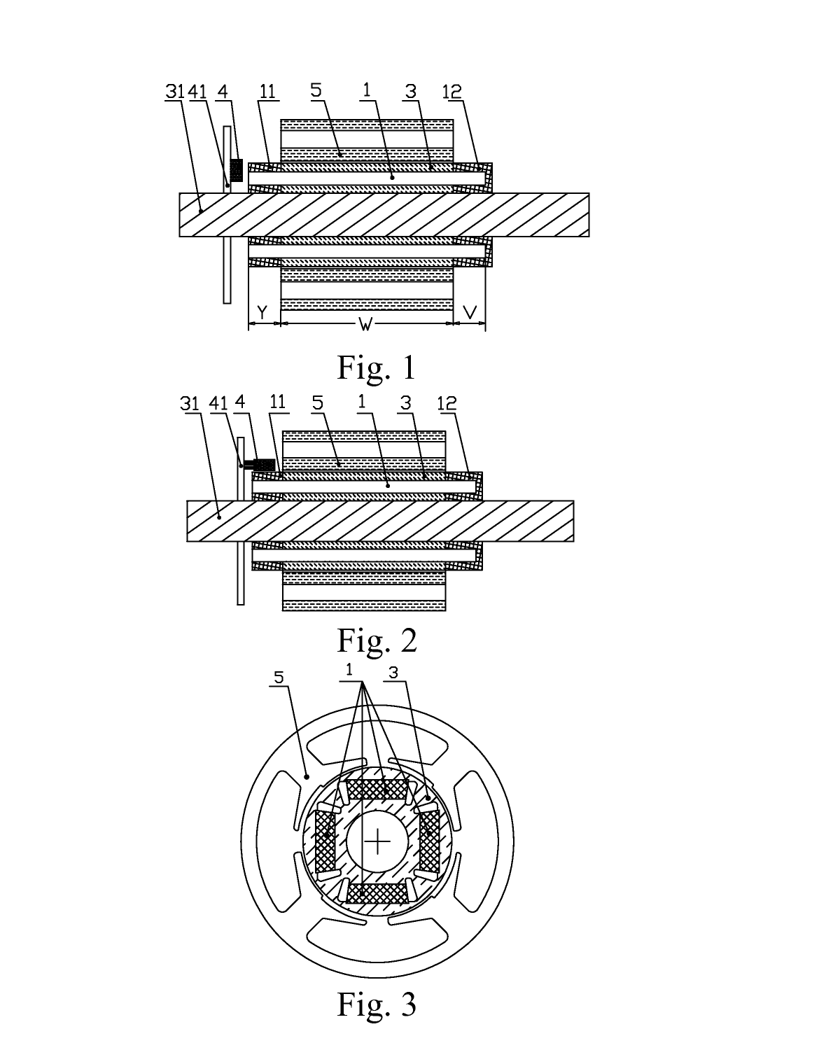

Referring to FIG. 1 of the drawings, according to a preferred embodiment of the present invention, a BLDC motor magnetic circuit comprises a stator iron core 5, a rotor iron core 3 having a plurality of stacked rotor punched sheets 30, permanent magnets 1 embedded within the rotor iron core 3, and a magneto-sensitive sensor 4 for detecting changes in a magnetic field of a rotor to accomplish a control of commutating. The rotor iron core 3 and the stator iron core 5 have an identical length which is shown as w in FIG. 1.

The permanent magnets 1 are longer than the rotor iron core 3; each permanent magnet 1 has at least one end protruding out of an end surface of the rotor iron core 3 to form a protrusion of the permanent magnet 1, respectively shown as Y and V in FIG. 1.

The magneto-sensitive sensor 4 is provided at an end of the rotor iron core 3 which is close to the protrusion of the permanent magnet 1 and far away from an impact of a magnetic field of a stator; the magneto-sensitive sensor 4 detects a position of the rotating rotor by sensing the changes in the magnetic field of the protrusions of the permanent magnets 1.

As shown in FIG. 2, the magneto-sensitive sensor 4 is mounted upright on the circuit board 41, wherein a sensing part of the magneto-sensitive sensor 4 is provided near external sides of the protrusions of the permanent magnets 1 and senses the changes in a magnetic field of the external sides of the protrusions of the permanent magnets 1.

As shown in FIG. 1, the magneto-sensitive sensor 4 lies down on the circuit board 41, wherein a sensing part of the magneto-sensitive sensor 4 is provided near the end surfaces of the permanent magnets 1 and senses the changes in a magnetic field of the ends of the permanent magnet 1.

As shown in FIG. 1, the protrusions of each permanent magnet 1 protruding out of the two ends of the rotor iron core 3 have an identical length, i.e., Y=V.

According to the preferred embodiment of the present invention, as shown in FIGS. 1 and 2, a permanent magnet front end cover 12 and a permanent magnet back end cover 11 are provided at the two ends of the rotor iron core 3; the permanent magnets 1 pass through the rotor iron core 3 and are mounted on a rotating shaft 31 via the permanent magnet front end cover 12 and the permanent magnet back end cover 11, so as to form the integral rotor of the BLDC motor.

According to the preferred embodiment of the present invention, as shown in FIGS. 1 and 2, the magneto-sensitive sensor 4 is provided near the permanent magnet back end cover 11. Alternatively, the magneto-sensitive sensor 4 can be provided near the permanent magnet front end cover 12. The circuit board 41 is mounted on the stator or an outer shell (unshown in the drawings) of the BLDC motor.

FIG. 3 shows a radially sectional view of the BLDC motor magnetic circuit. Preferably, the number of the pairs of the magnetic poles of the BLDC motor p=2; the stator iron core 5 has two pairs of magnetic poles; and the rotor iron core 3 has four permanent magnets 1.

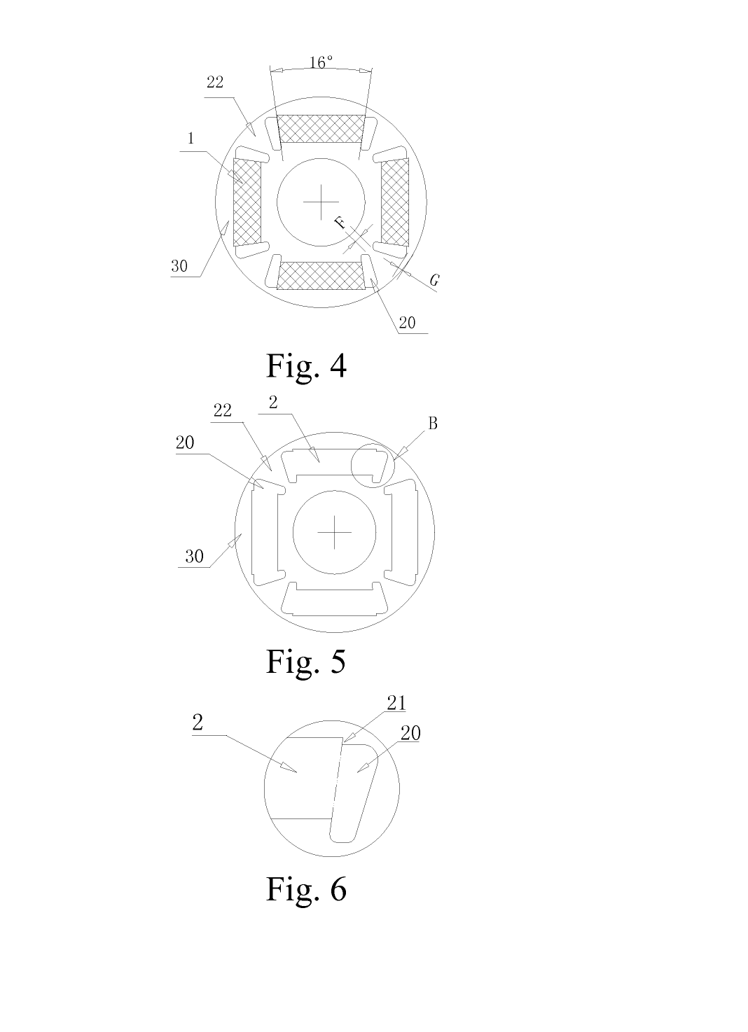

As shown in FIG. 4, according to the preferred embodiment of the present invention, a permanent magnet embedded rotor of the BLDC motor magnetic circuit comprises the rotor iron core having the plurality of the stacked rotor punched sheets 30, p pairs of permanent magnet slots 2 uniformly provided at a circumference of the rotor punched sheets 30, and p pairs of the permanent magnets 1 respectively embedded in the permanent magnet slots 2, wherein p is an integer no less than 1; and outer peripheries of the rotor punched sheets 30 are standard circular arcs.

As shown in FIG. 7, the two ends of the permanent magnet 1 both tilt inwardly at a tilting angle Q, for improving two superficial magnetic convex waveforms emerging at a boundary between two magnetic poles of the permanent magnet 1. Preferably, Q=5°˜20°; as shown in FIG. 4, Q=8° and the two end surfaces of each permanent magnet 1 forms an angle of 16°.

Magnetic screening slots 20 are respectively provided at the two ends of each permanent magnet slot 2.

Positioning convex portions 21 for mounting the permanent magnet 1 are provided at a boundary between the two ends of each permanent magnet slot 2 and each magnetic screening slot 20 (shown as a double dotted line in FIG. 6).

According to the preferred embodiment of the present invention, as shown in FIGS. 4 and 5, the magnetic screening slot 20 is a bar-shaped space extending along the end surface of the permanent magnet 1. As shown in FIG. 6, a cross section of the bar-shaped space is formed by a straight line substantially parallel with the end surface of the permanent magnet 1 and smooth curves connected between two ends of the straight line and the permanent magnet slot 2. As shown in FIGS. 4 and 5, sector-shaped connecting zones 22 of the punched sheets are provided between the two adjacent magnetic screening slots 20.

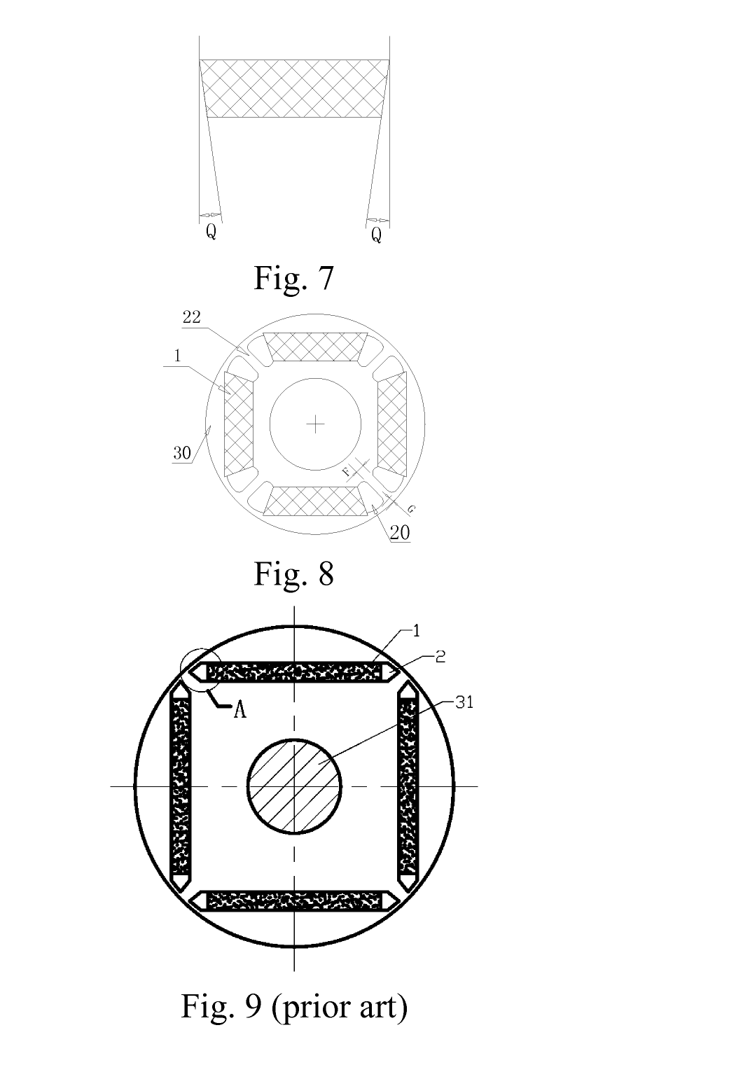

FIG. 8 shows an alternative mode of the permanent magnet embedded rotor, wherein the magnetic screening slot 20 is a sector-shaped space extending along the end surface of the permanent magnet 1; a cross section of the sector-shaped space is formed by a straight line substantially radially parallel with the rotor punched sheets and smooth curves connected between two ends of the straight line and the permanent magnet slot 2; bar-shaped connecting zones 22 of the punched sheets are provided between the two adjacent magnetic screening slots 20. A structure of the alternative mode is suitable for manufacture; a length of a magnetic screening bridge can be increased by elongating a distance F between boundaries of the two adjacent magnetic screening slots 20, so as to reduce a magnetic flux leakage coefficient.

According to the preferred embodiment of the present invention, as shown in FIGS. 4, 5 and 8, the plurality of the rotor punched sheets 30 is integrally punched and molded; the number of the pairs of magnetic poles p=2; four permanent magnet slots 2 and eight magnetic screening slots 20 distributed at the two ends of each permanent magnet slots 2. The distance F between the boundaries of the two adjacent magnetic screening slots 20 is 0.5˜3 mm; a distance G between the boundary of the magnetic screening slot 20 and an outer boundary of the rotor punched sheet 30 is 0.5˜3 mm. The permanent magnet embedded rotor of the present invention accomplishes controlling a magnetic flux leakage coefficient of each magnetic pole by controlling a saturation of partial magnetic density, so as to increase superficial magnetism of each magnetic pole of the rotor and also utilization of the permanent magnets. In the preferred embodiment of the present invention, each permanent magnet 1 is embodied as a bar-shaped permanent magnet having a trapezoidal cross section; each permanent magnet slot 2 is embodied as a trapezoidal space formed by multiple segments, wherein the multiple segments correspond to the trapezoidal cross section of the permanent magnet 1. In other preferred embodiments of the present invention, the permanent magnets 1 can be arc-shaped and the permanent magnet slot 2 can be an arc-shaped space having an accordant cross section with the permanent magnet 1.

According to the preferred embodiment of the present invention, as shown in FIGS. 4, 5 and 8, the number of the pairs of the magnetic poles p=2; the number of the pairs of the correspondent permanent magnets 1 is 2. In other preferred embodiments of the present invention, the BLDC motor can have a different value of p, the number of the pairs of the magnetic poles. For example, the BLDC motor have 1, 3, 4 or 5 pairs of the magnetic poles and correspondently 1, 3, 4 or 5 pairs of the permanent magnets 1.

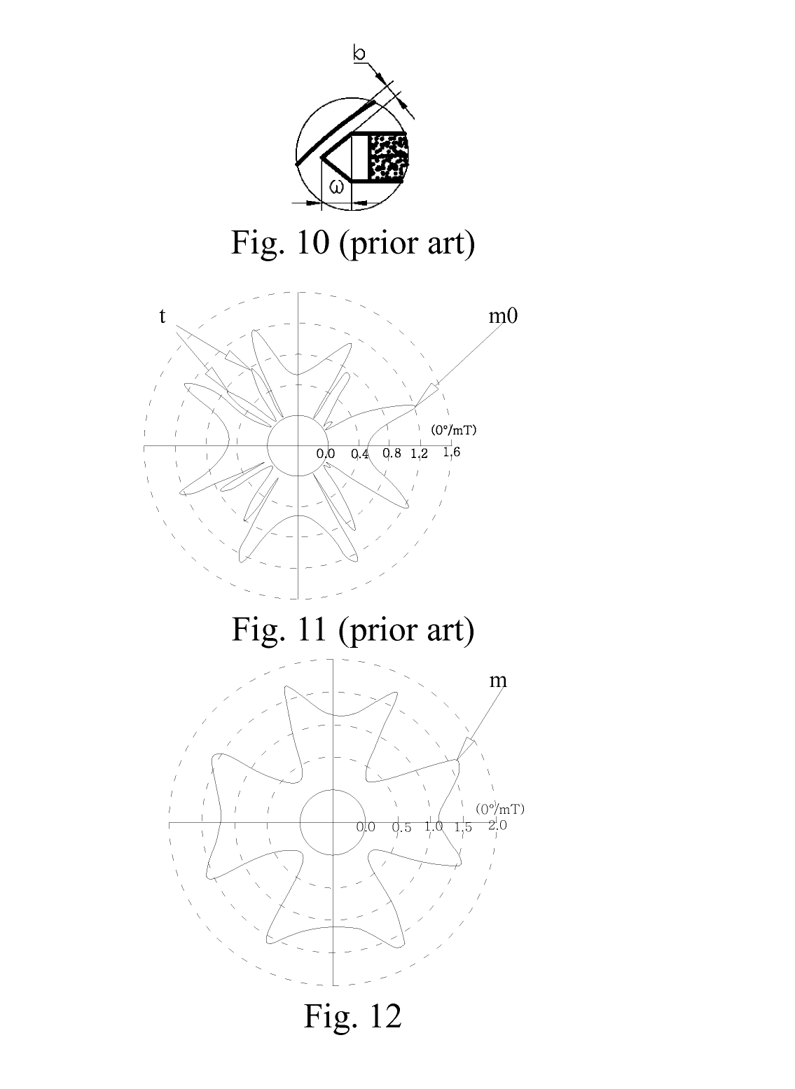

Compared with the prior arts, the BLDC motor provided by the present invention changes the magnetic density direction of the permanent magnets within the rotor, obviously improves the partial magnetic density direction and eliminates the magnetic density mutation via the reasonable rotor arrangement and the permanent magnets having tilted ends, so as to greatly improve the superficial magnetism curve of the rotor. FIG. 12 shows a distribution diagram of the superficial magnetism of the permanent magnet embedded rotor. By a comparison between the distribution diagram and a conventional distribution diagram as shown in FIG. 11, it is indicated that two convex waveforms (t in FIG. 11) on the superficial magnetism curve are effectively suppressed, which greatly reduces Hall signal jitters during commutating, avoids waveform mutations outputted by driving circuits and reduces torque fluctuations outputted by the motor, so as to obtain a smooth operation and an improved operation efficiency.

By the above comparison between FIG. 12 and FIG. 11, it is also indicated that, despite of the identical permanent magnets with the superficial magnetism of 200 mT, an average value of the superficial magnetism correspondent to each magnetic pole of the rotor of the BLDC motor of the present invention is 140 mT (shown as a scale of FIG. 12); whereas the average value of the superficial magnetism correspondent to each magnetic pole of the conventional rotor of the conventional BLDC motor of the prior arts is 90 T (shown as a scale of FIG. 11). Thus, compared with the prior arts, the average value of the superficial magnetism of the present invention is increased more than 50%. Meanwhile, by a comparison between a conventional superficial magnetism waveform m0, shown in FIG. 11, and a superficial magnetism waveform m, shown in FIG. 12, it is indicated that the superficial magnetism waveform correspondent to each magnetic pole of the present invention has an obviously improved saddle shape, so as to obtain a better integral performance and a higher power density.

Besides, via the stacked rotor punched sheets 30, all the magnetic screening slots 20 within the rotor form a channel for ventilation and thermal dissipation, so that the rotor has good effects of thermal dissipation and saves raw materials; compared with the conventional rotor comprising a salient pole rotor or a rotor having a V-shaped recess, the BLDC motor of the present invention obtains better effects of dynamic balance and less wind noise, so as to accomplish lower costs and better performance.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

1-6. (canceled)

7. A brushless direct current (BLDC) motor magnetic circuit, comprising a stator iron core, a rotor iron core having a plurality of stacked rotor punched sheets, permanent magnets embedded within said rotor iron core, and a magneto-sensitive sensor for detecting changes in a magnetic field of a rotor to accomplish a control of commutation, wherein
said rotor iron core and said stator iron core have an identical length; said permanent magnets are longer than said rotor iron core;
each said permanent magnet has at least one end protruding out of an end surface of said rotor iron core to form a protrusion of said permanent magnet; and
said magneto-sensitive sensor is provided at an end of said rotor iron core which is close to said protrusions of said permanent magnets and far away from an impact of a magnetic field of a stator; said magneto-sensitive sensor detects a position of said rotating rotor by sensing changes in a magnetic field of said protrusions of said permanent magnets.

8. The BLDC motor magnetic circuit, as recited in claim 7, further comprising a circuit board for mounting said magneto-sensitive sensor upright thereon, wherein a sensing part of said magneto-sensitive sensor is close to an external side of each said protrusion and senses said changes in said magnetic field at said external side of each said protrusion of each said permanent magnet when said rotor is rotating.

9. The BLDC motor magnetic circuit, as recited in claim 7, further comprising a circuit board where said magneto-sensitive sensor lies down, wherein a sensing part of said magneto-sensitive sensor is close to an end surface of each said permanent magnet and senses said changes in said magnetic field of said ends of each said permanent magnet when said rotor is rotating.

10. The BLDC motor magnetic circuit, as recited in claim 7, wherein said protrusions of said permanent magnets protruding out of said ends of said rotor iron core have an identical length.

11. The BLDC motor magnetic circuit, as recited in claim 8, wherein said protrusions of said permanent magnets protruding out of said ends of said rotor iron core have an identical length.

12. The BLDC motor magnetic circuit, as recited in claim 9, wherein said protrusions of said permanent magnets protruding out of said ends of said rotor iron core have an identical length.

13. The BLDC motor magnetic circuit, as recited in claim 7, further comprising a permanent magnet front end cover and a permanent back end cover provided at said two ends of said rotor iron core, wherein each said permanent magnet passes through said rotor iron core and is fixed on a rotating shaft via said permanent magnet front end cover and said permanent magnet back end cover, for forming said integral rotor of said BLDC motor.

14. The BLDC motor magnetic circuit, as recited in claim 8, further comprising a permanent magnet front end cover and a permanent back end cover provided at said two ends of said rotor iron core, wherein each said permanent magnet passes through said rotor iron core and is fixed on a rotating shaft via said permanent magnet front end cover and said permanent magnet back end cover, for forming said integral rotor of said BLDC motor.

15. The BLDC motor magnetic circuit, as recited in claim 9, further comprising a permanent magnet front end cover and a permanent back end cover provided at said two ends of said rotor iron core, wherein each said permanent magnet passes through said rotor iron core and is fixed on a rotating shaft via said permanent magnet front end cover and said permanent magnet back end cover, for forming said integral rotor of said BLDC motor.

16. A permanent magnet embedded rotor of a BLDC motor magnetic circuit as recited in claim 7, comprising said rotor iron core having said plurality of said stacked rotor punched sheets, p pairs of permanent magnet slots uniformly provided at a circumference of said rotor punched sheets, and p pairs of said permanent magnets respectively embedded in said permanent magnet slots, wherein
p is an integer no less than 1; each said rotor punched sheet has an outer periphery of a standard circular arc;
said two ends of each said permanent magnet both tilt inwardly at a tilting angle Q, wherein Q=5°˜20°;
a magnetic screening slot is provided at each said end of each said permanent magnet slot; and
a positioning convex portion for mounting each said permanent magnet is provided at each boundary between said two ends of each said permanent magnet slot and each said magnetic screening slot.

17. The permanent magnet embedded rotor as recited in claim 16, wherein each said magnetic screening slot is a bar-shaped space extending along said end surfaces of each said permanent magnet, wherein a cross section of said bar-shaped space is formed by a straight segment substantially parallel with said end surface of said permanent magnet and two smooth curves connected between two ends of said straight segment and said permanent magnet slot; a sector-shaped connecting zone of said punched sheets is provided between said two adjacent magnetic screening slots.

18. The permanent magnet embedded rotor as recited in claim 16, wherein each said magnetic screening slot is a sector-shaped space extending along said end surfaces of each said permanent magnet, wherein a cross section of said sector-shaped space is formed by a straight segment substantially radially parallel with said rotor punched sheet and two smooth curves connected between two ends of said straight segment and said permanent magnet slot; a bar-shaped connecting zone of said punched sheets is provided between said two adjacent magnetic screening slots.

19. The permanent magnet embedded rotor as recited in claim 16, wherein a distance F between boundaries of said two adjacent magnetic screening slots is 0.5˜3 mm.

20. The permanent magnet embedded rotor as recited in claim 17, wherein a distance F between boundaries of said two adjacent magnetic screening slots is 0.5˜3 mm.

21. The permanent magnet embedded rotor as recited in claim 18, wherein a distance F between boundaries of said two adjacent magnetic screening slots is 0.5˜3 mm.

22. The permanent magnet embedded rotor as recited in claim 16, wherein a distance G between a boundary of said magnetic screening slot and said outer arc-shaped periphery of said rotor punched sheet is 0.5˜3 mm.

23. The permanent magnet embedded rotor as recited in claim 17, wherein a distance G between a boundary of said magnetic screening slot and said outer arc-shaped periphery of said rotor punched sheet is 0.5˜3 mm.

24. The permanent magnet embedded rotor as recited in claim 18, wherein a distance G between a boundary of said magnetic screening slot and said outer arc-shaped periphery of said rotor punched sheet is 0.5˜3 mm.
